(19) United States
(12) Patent Application Publication
(10) Pub. No.: US 2013/0340640 A1
(43) Pub. Date: Dec. 26, 2013

(54) FRAME UNIT, MEDIUM HOLDING DEVICE AND RECORDING APPARATUS

(71) Applicant: SEIKO EPSON CORPORATION, Tokyo (JP)

(72) Inventor: Kenji YANAGISHITA, Matsumoto-shi (JP)

(73) Assignee: Seiko Epson Corporation, Tokyo (JP)

(21) Appl. No.: 13/800,992

(22) Filed: Mar. 13, 2013

(30) Foreign Application Priority Data
Jun. 21, 2012 (JP) 2012-139343

(51) Int. Cl. B41F 17/00

(52) U.S. Cl. CPC B41F 17/005
USPC 101/474

(57) ABSTRACT

A medium holding device that includes a frame unit for holding a medium on a tray after the medium is set on the tray, and that includes a base frame capable of being fitted onto the outer side of the tray on which the medium has been set and a moving member which is provided in the base frame and is movable in an inside-outside direction of the base frame.

### BACKGROUND

1. Technical Field

The present invention relates to frame units that hold media, medium holding devices and recording apparatuses.

2. Related Art

Various kinds of medium holding devices have been used. Of those medium holding devices, such a medium holding device is used that includes a tray on which a medium is set and a frame unit that is fitted onto the outer side of the tray to hold the medium having been set on the tray. As a medium to be held by such medium holding device, for example, fabric is used. Various types of materials of various thicknesses are provided as fabric, and it is to be noted that fabric is more likely to wrinkle than other media such as recording paper and the like.

For example, in JP-A-2003-312069, a platen device is disclosed as a medium holding device capable of using fabric as a medium. This platen device includes a platen where a medium can be insert and mounted. Further, the above platen device has an outer frame member that can pinch the medium having been inserted and mounted on the platen; accordingly, it is possible to apply tension to the medium by pinching the medium with this outer frame member.

The platen device disclosed in JP-A-2003-312069 has a structure in which tension is applied to a medium that has been inserted and mounted on the platen by pinching the medium with the outer frame member. Accordingly, it is possible to suppress the generation of wrinkles in a medium of a predetermined thickness by applying the tension to the medium. However, there has been a case in which a medium whose thickness exceeds the predetermined thickness cannot be pinched with the outer frame member. Further, there also has been a case in which a desired tension cannot be applied to a medium whose thickness is less than the predetermined thickness when the medium is pinched with the outer frame member.

### SUMMARY

An advantage of some aspects of the invention is to make it possible to process media of different thicknesses and remove wrinkles in the media that are likely to be wrinkled.

A frame unit according to a first aspect of the invention is a frame unit that holds a medium on a tray after the medium is set on the tray and that includes a base frame capable of being fitted onto the outer side of the tray on which the medium has been set and a moving member which is provided in the base frame and is movable in an inside-outside direction of the base frame.

According to this aspect, a user can fit the base frame onto the tray on which a medium has been set, remove wrinkles in the medium, and then move the moving member to the inner side of the base frame to press the medium against the tray. In other words, it is possible to pinch the medium between the tray and the moving member located in the periphery of the tray while the wrinkles in the medium are removed. This makes it possible to hold the medium on the tray in a state in which the wrinkles are removed.

Further, in the frame unit according to this aspect, the moving member is movable in the inside-outside direction of the base frame. Therefore, it is possible to move the moving member to an outside direction of the base frame when the base frame is to be fitted onto the tray, and move the moving member to an inside direction of the base frame when the medium is to be held on the tray. Accordingly, in the frame unit according to the aspect, since a relatively larger base frame can be used compared to the tray, it is possible to use a thick medium. That is, the frame unit of this aspect can process media of various thicknesses.

In a frame unit according to a second aspect of the invention, it is preferable that the frame unit of the first aspect include a bias member that biases the moving member to the inside direction of the base frame.

According to this aspect, the moving member is biased to the inside direction of the base frame. Through this, it is possible to firmly hold a medium on the tray on which the medium has been set so that the generation of wrinkles in the medium is effectively suppressed after the medium is held on the tray.

In a frame unit according to a third aspect of the invention, it is preferable for the moving members in the frame unit of the first or second aspect to be provided at least at positions opposite to each other of the base frame.

Here, “positions opposite to each other of the base frame” are positions facing each other in the base frame. However, the positions mentioned above are not limited to the positions precisely facing each other. For example, in a case of a base frame having opposing sides, if the moving members are provided on the two opposing sides of the base frame, the stated configuration is included in the scope of the invention even if the moving members are deviated from the positions precisely facing each other.

In addition, movement directions of a pair of moving members provided at the “positions opposite to each other of the base frame” are not limited to the directions exactly opposite to each other, and may be slightly inclined relative to each other.

According to this aspect, it is possible to hold a medium by pressing the medium against the tray at least from the positions opposite to each other of the base frame. Therefore, the medium which has been set on the tray can be held from the positions facing the tray, which makes it possible to effectively suppress the generation of wrinkles in the medium after the medium is held on the tray.

In a frame unit according to a fourth aspect of the invention, it is preferable for the tray and the base frame in the frame unit of the third aspect to be quadrilateral and for the moving members in the frame unit of the third aspect to be provided on at least two opposing sides of the base frame.

According to this aspect, because the tray is formed in a quadrilateral shape, the medium can be set thereupon with ease. In addition, it is possible to hold the medium by pressing the medium against the tray from the two opposing sides of the quadrilateral base frame. Accordingly, the medium which has been set on the tray can be held from the two sides facing to the tray, whereby the generation of wrinkles in the medium is effectively suppressed after the medium is held on the tray. Note that, it is preferable for the “quadrilateral” to be a rectangle, a square, or the like; however, the shape is not limited thereto.

In a frame unit according to a fifth aspect of the invention, it is preferable in the frame unit of the second aspect that a contact surface of the moving member with which the medium makes contact when the base frame is fitted be inclined with respect to a setting surface of the tray so that the moving member is applied a force from the tray toward the outside direction of the base frame when the base frame is fitted onto the tray on which the medium has been set.

According to this aspect, a force is applied to the moving member toward the outside direction of the base frame in synchronization with operation of fitting the base frame onto the tray on which the medium has been set. Since the moving member to which the force toward the outside direction is applied moves to the outside direction, tension is applied to the medium set on the tray in a direction in which the wrinkles are smoothed out and removed. Upon finishing the operation of fitting the base frame, the moving member is biased toward the inside direction of the base frame, whereby the medium having been set on the tray is held on the tray. In other words, a user can easily remove the wrinkles by carrying out the operation of fitting the base frame onto the tray on which the medium has been set, and suppress the generation of wrinkles in the medium after the above fitting operation.

In a frame unit according to a sixth aspect of the invention, it is preferable for the moving members in the frame unit of the fourth aspect to be provided on the four sides of the base frame.

According to this aspect, it is possible to press the medium against the tray from the four sides of a rectangular base frame so as to hold the medium. This makes it possible to hold the medium on the tray on which the medium has been set from the four sides, whereby the generation of wrinkles in the medium is effectively suppressed after holding the medium on the tray.

In a frame unit according to a seventh aspect of the invention, it is preferable for the frame unit of any one of the first through sixth aspects to include a knob that can be used when the moving member is moved.

According to this aspect, a user can hold the knob and easily move the moving member.

A medium holding device according to an eighth aspect of the invention includes a tray on which a medium is set and the frame unit of any one of the first through seventh aspects.

According to this aspect, with the medium holding device including the tray and the frame unit, the same action effect can be obtained as the frame units of the aforementioned aspects.

A recording apparatus according to a ninth aspect of the invention includes the medium holding device of the eighth aspect and a recording section that performs recording on the aforementioned medium.

According to this aspect, with the recording apparatus such as an ink jet recording apparatus or the like, the same action effect can be obtained as with the medium holding device of the aforementioned aspect.

### BRIEF DESCRIPTION OF THE DRAWINGS

The invention will be described with reference to the accompanying drawings, wherein like numbers reference like elements.

FIG. 1 is a schematic perspective view of a recording apparatus according to a first embodiment of the invention.

FIG. 2 is a schematic side view of a recording apparatus according to the first embodiment of the invention.

FIGS. 3A and 3B are perspective views illustrating an example of a medium according to the invention.

FIGS. 4A and 4B are schematic perspective views of a principal portion of a recording apparatus according to the first embodiment of the invention.

FIGS. 5A and 5B are schematic cross-sectional views of a principal portion of the recording apparatus according to the first embodiment of the invention.

FIGS. 6A and 6B are schematic cross-sectional views of a principal portion of a recording apparatus according to a second embodiment of the invention.

FIGS. 7A and 7B are schematic cross-sectional views of a principal portion of a recording apparatus according to a third embodiment of the invention.

FIGS. 8A and 83 are schematic perspective views of a principal portion of a recording apparatus according to a fourth embodiment of the invention.

### DESCRIPTION OF EXEMPLARY EMBODIMENTS

Hereinafter, recording apparatuses according to embodiments of the invention will be described in detail with reference to the appended drawings.

In any of the following embodiments, a frame unit and a medium holding device that includes the frame unit and a tray on which a medium is set will be explained; note that the stated frame unit and medium holding device are used in a recording apparatus. However, the frame unit and the medium holding device of the invention are not limited to those used in a recording apparatus. Note that the description of a recording apparatus is given using an ink jet recording apparatus that performs recording by discharging ink from a recording head. However, the recording apparatus of the invention is limited to the ink jet recording apparatus.

Further, in any of the following embodiments, the description of a medium will be given using a T-shirt, which is fabric. However, the medium that can be used in the invention is not limited to T-shirts and also not limited to fabric.

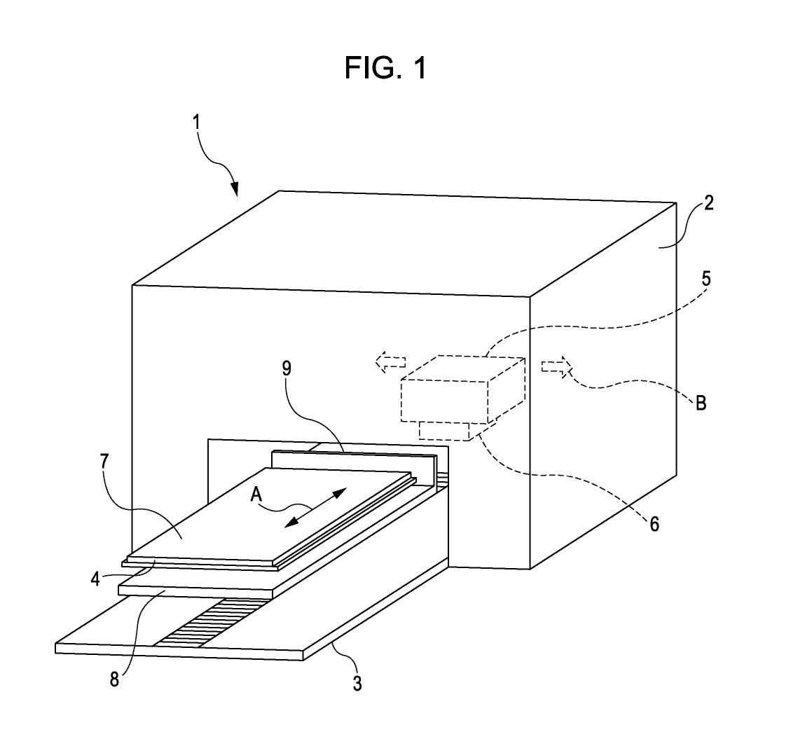

### First Embodiment (FIG. 1 Through FIG. 5B)

FIG. 1 is a schematic perspective view of a recording apparatus according to a first embodiment of the invention.

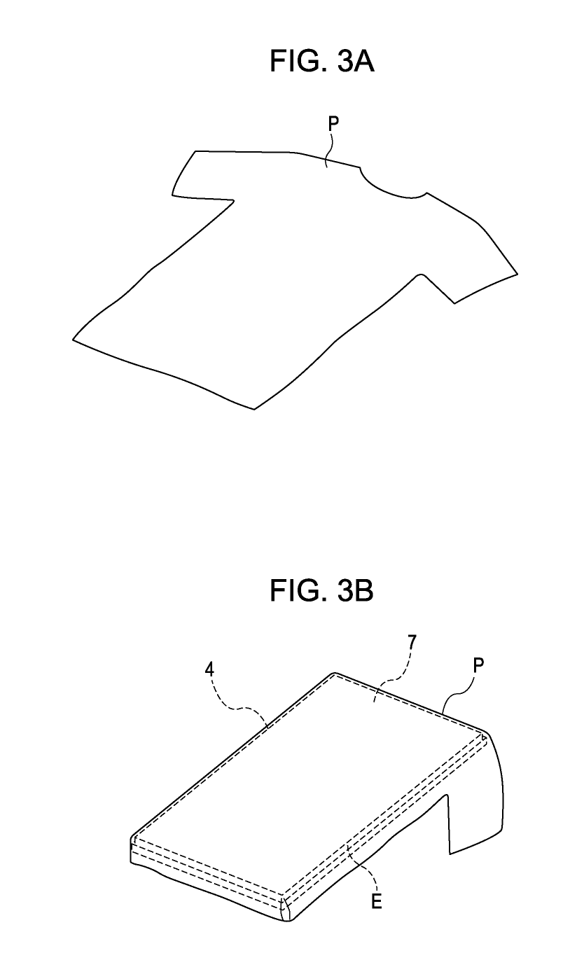

As shown in FIG. 1, a recording apparatus 1 according to this embodiment includes a tray 4 having a setting surface 7 on which a medium P (see FIGS. 3A and 3B) is set. A transport section 3 transports the medium P by moving the tray 4 in a transport direction A along the setting surface 7. A receiving tray 8 that can receive a part of the medium P sticking out from the setting surface 7 is provided under the tray 4. The receiving tray 8 is equipped with a plate member 9 to conceal the interior of the recording apparatus 1.

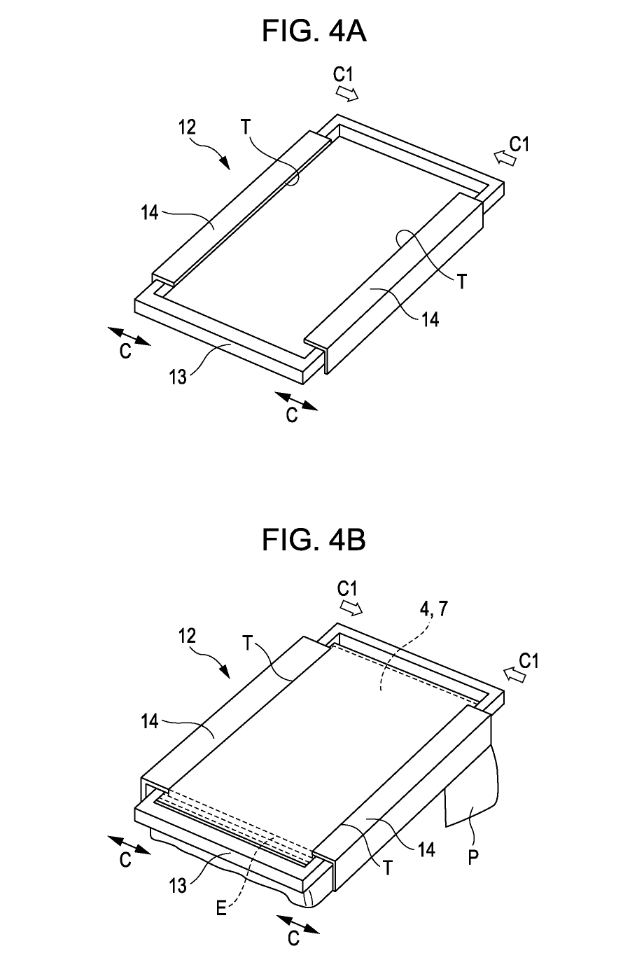

The tray 4 of this embodiment is detachable from the recording apparatus 1. Accordingly, a user can set the medium P in a state in which the tray 4 is detached from the recording apparatus 1. The user sets the medium P on the tray 4, which is detached from or attached to the recording apparatus 1. Thereafter, a frame unit 12 (see FIGS. 4A and 4B) is fitted onto the tray 4, the tray 4 is attached to the recording apparatus 1 if the tray 4 is in a state of being detached in the manner described above, and then recording can be performed.

A main apparatus body 2 includes a recording head 6. The recording apparatus 1 forms a desired image by discharging ink from the recording head 6 onto the medium P while moving the recording head 6 back and forth via a carriage 5 in a scanning direction B that intersects with the transport direction A.

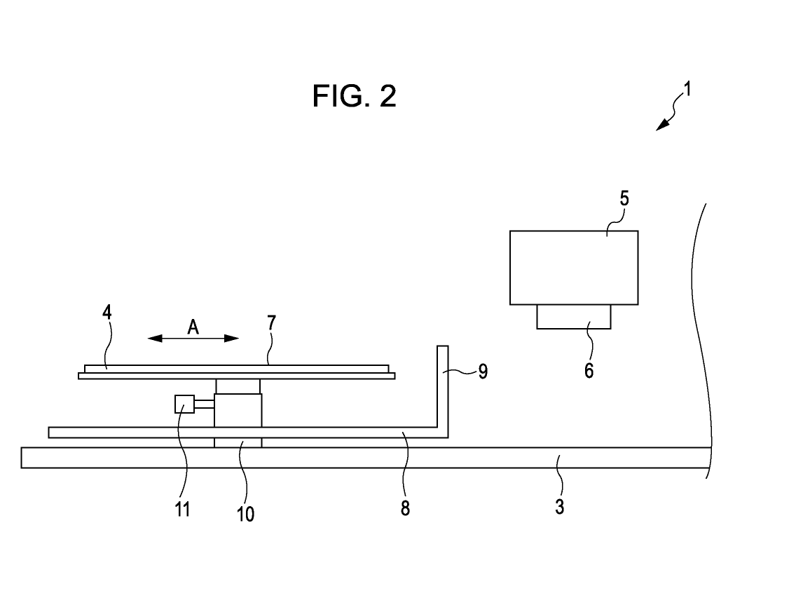

FIG. 2 is a schematic side view of the recording apparatus according to the first embodiment of the invention.

A user can adjust the height of the setting surface 7 of the tray 4 by rotating a height adjustment lever 11 that is provided on a support mechanism 10. Note that the tray 4, the support mechanism 10, the height adjustment lever 11, the receiving tray 8, and the plate member 9 are moved all together in the transport direction A by the transport section 3.

Of FIGS. 3A and 3B, FIG. 3A is a perspective view illustrating an example of a medium of the invention, and FIG. 3B is a perspective view illustrating a state in which the medium is set on the tray 4.

FIG. 3A illustrates a T-shirt as the medium P of this embodiment. The medium P is set on the setting surface 7 of the tray 4 sticking out from an edge E of the tray 4, as shown in FIG. 3B.

Of FIGS. 4A and 4B, FIG. 4A is a schematic perspective view of the frame unit 12 as a principal portion of the recording apparatus according to the first embodiment of the invention, and FIG. 4B is a perspective view illustrating a state in which the frame unit 12 is fitted onto the tray 4 on which the medium P is set. Note that the medium holding device of this embodiment is configured with the tray 4 and the frame unit 12.

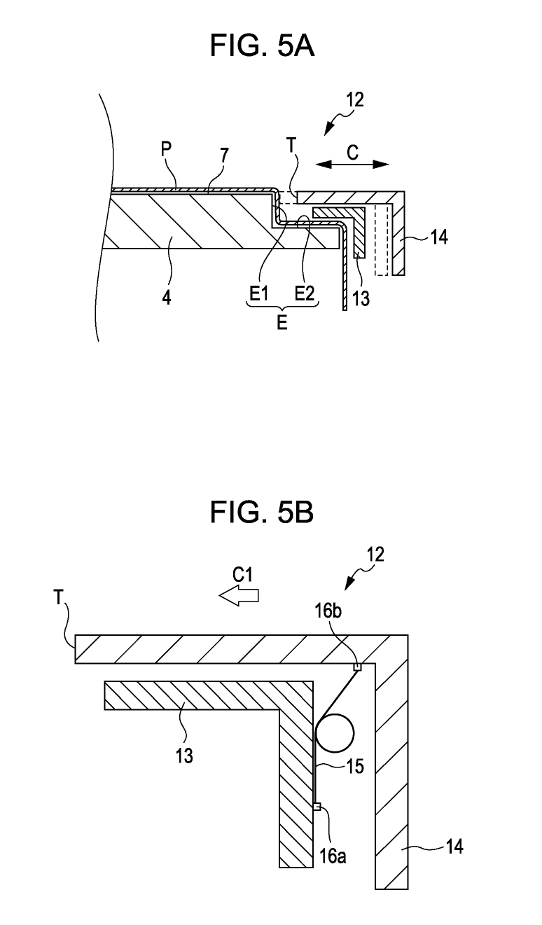

As shown in FIG. 4A, the frame unit 12 of this embodiment includes a rectangular base frame 13 corresponding to the rectangular tray 4 and a pair of moving members 14 provided on the two opposing sides of the base frame 13. The moving member 14 is attached to the base frame 13 in a movable manner in an inside-outside direction C of the base frame 13 via a connection mechanism (not shown). Further, the moving member 14 is biased toward an inside direction C1 of the base frame 13 by a torsion coil spring 15 (see FIGS. 5A and 5B) as a bias member.

FIG. 4B is a perspective view illustrating a state in which the frame unit 12 is fitted onto the tray 4. The frame unit 12 of this embodiment can be fitted onto the tray 4 from the setting surface 7 side. However, the frame unit of the invention is not limited to the configuration of this embodiment. In addition, the tray 4 and the frame unit 12 may be partly connected in a rotatable manner.

The frame unit 12 of this embodiment presses leading edges T of the moving members 14 against the medium P at an edge E portion of the tray 4 from the two opposing sides of the base frame 13 so as to hold the medium P on the tray 4. The edge E portion configures a step structure having a rising portion E1 and a horizontal portion E2 extending to the outside of the rising portion E1 (see FIGS. 5A and 5B). As described above, with the configuration in which the medium P is held on the tray 4 by moving the moving members 14, it is possible to use the base frame 13 which is relatively larger compared to the tray 4. This makes it possible to set media P of various thicknesses on the tray 4.

The moving member 14 of this embodiment is so configured as to make line contact with the medium P set on the tray 4 in a direction along the setting surface 7. Accordingly, the moving member 14 of this embodiment can more effectively maintain a state in which wrinkles in the medium P set on the tray 4 are removed than the moving member 14 that is so configured as to make point contact. However, the invention is not limited to the configuration of this embodiment.

The frame unit 12 of this embodiment is configured so that the moving members 14 are provided on the two opposing sides of the base frame 13. The medium P can be firmly held because the medium P can be held on the tray 4 by pressing the moving members 14 against the medium P from the two opposing sides of the base frame 13.

However, the frame unit of the invention is not limited to the above configuration. For example, the frame unit may be configured so that the moving member 14 is provided on only one side of the base frame 13. With the frame unit of this configuration, the media P at an edge E portion is pressed against a side of the base frame 13 that is opposite to the side thereof on which the moving member 14 is provided; then, while maintaining the above pressing state, the moving member 14 is pressed against the medium P at another edge E portion so as to hold the medium P on the tray 4.

FIGS. 5A and 5B are enlarged schematic cross-sectional views illustrating the frame unit 12, which is a principal portion of the recording apparatus according to the first embodiment of the invention.

FIG. 5A is a schematic cross-sectional view illustrating a positional relationship between the tray 4 and the frame unit 12 when the frame unit 12 is fitted onto the tray 4 on which the medium P is set. The leading edge T of the moving member 14 can be in contact with the medium P at the edge E portion by the movement of the moving member 14 in the inside-outside direction C. To be more specific, fitting the frame unit 12 onto the tray 4 causes the base frame 13 to make contact with the medium P on the horizontal portion E2 and also causes the leading edge T of the moving member 14 to make contact with the medium P beside the rising portion E1.

FIG. 5B is a schematic cross-sectional view of the frame unit 12. The moving member 14 is biased toward the inside direction C1 with respect to the base frame 13 by the torsion coil spring 15 as the bias member. The torsion coil spring 15 is connected to the base frame 13 via a connecting portion 16a, and is connected to the moving member 14 via a connecting portion 16b.

Although the frame unit 12 of this embodiment uses the torsion coil spring 15 as the bias member, the invention is not limited thereto. For example, a plate spring, a bar spring, or the like can be used as the bias member.

Although the frame unit 12 of this embodiment is configured so that the moving member 14 is biased by the bias member with respect to the base frame 13, the frame unit of the invention is not limited to the above configuration. For example, the frame unit may have a configuration in which the bias member is not provided and the moving member can be stopped by friction with respect to the base frame.

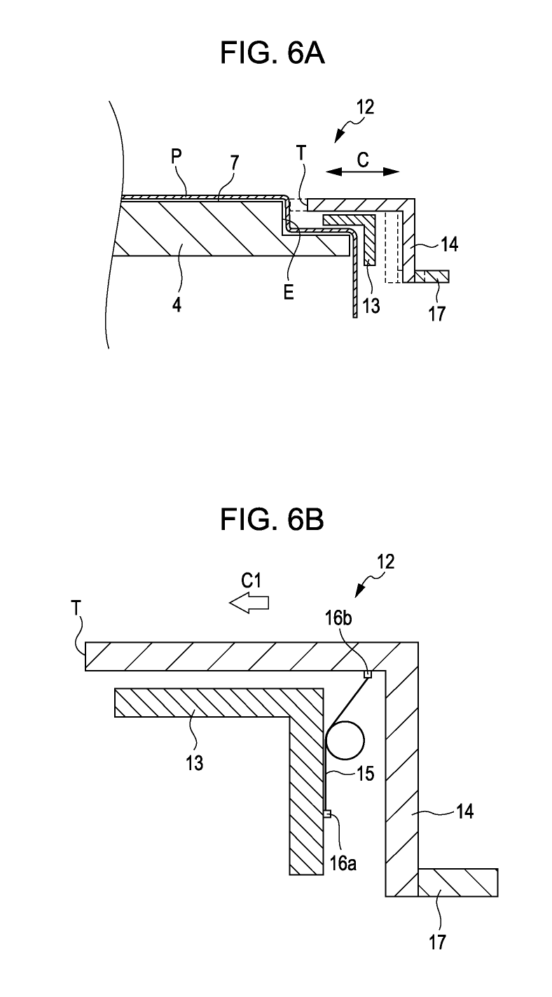

### Second Embodiment (FIGS. 6A and 6B)

FIGS. 6A and 6B are enlarged schematic cross-sectional views illustrating a principal portion (frame unit 12) of a recording apparatus according to a second embodiment of the invention. Note that the same constituent members as those of the first embodiment are given the same reference numerals and detailed descriptions thereof are omitted.

In the frame unit 12 of this embodiment, a knob 17 is provided in the moving member 14 so that a user can move the moving member 14 in the inside-outside direction C with ease. The frame unit 12 of this embodiment has the same configuration as the frame unit 12 of the first embodiment except that the knob 17 is provided at the central portion in the lengthwise direction of the moving member 14.

The knob 17 of this embodiment is provided at the lower side of the moving member 14 and is formed in a plate shape extending in a depth direction of the drawing (direction vertical to the paper surface). However, the invention is not limited to this configuration.

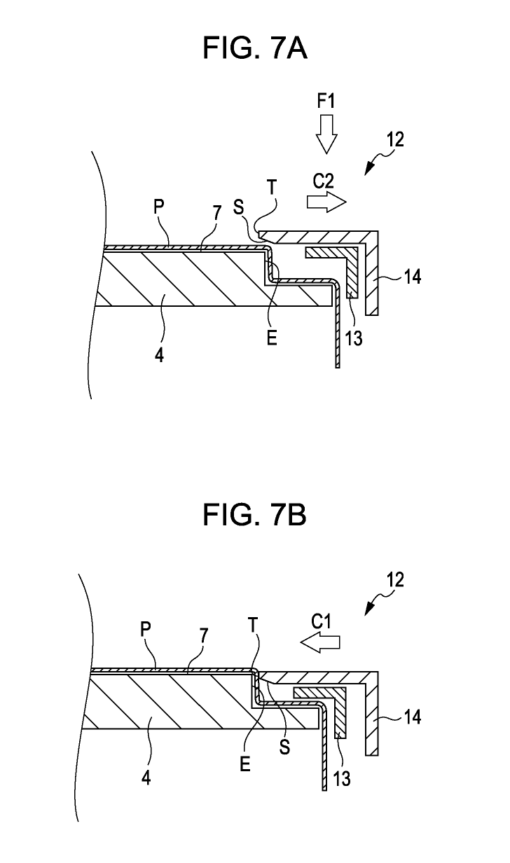

### Third Embodiment (FIGS. 7A and 7B)

FIGS. 7A and 7B are enlarged schematic cross-sectional views illustrating a principal portion (frame unit 12) of a recording apparatus according to a third embodiment of the invention. Note that the same constituent members as those of the first embodiment are given the same reference numerals and detailed descriptions thereof are omitted.

FIG. 7A is a schematic cross-sectional view illustrating a positional relationship between the tray 4 and the frame unit 12 before the frame unit 12 is fitted onto the tray 4 on which the medium P has been set. A user can fit the frame unit 12 onto the tray 4 by pressing the frame unit 12 in a lower-side direction F1 from a position thereof indicated in FIG. 7A with respect to the tray 4.

The leading edge T of the moving member 14 is tapered. In other words, a contact surface S of the moving member 14 to make contact with the medium P when the base frame 13 is fitted is inclined with respect to the setting surface 7 so that a force is applied to the moving member 14 from the tray 4 to an outside direction C2 of the base frame 13 when the frame unit 12 is fitted onto the tray 4. With this, when the leading edge T is pressed in the lower-side direction F1 against the medium P at the edge E portion of the tray 4, the moving member 14 is applied a force toward the outside direction C2 and is moved in the outside direction C2. Note that the frame unit 12 of this embodiment has the same configuration as the frame unit 12 of the first embodiment except that the leading edge T is tapered.

FIG. 7B is a schematic cross-sectional view illustrating a positional relationship between the tray 4 and the frame unit 12 after the frame unit 12 is fitted onto the tray 4 on which the medium P has been set. When the frame unit 12 is fitted onto the tray 4, a bias force is applied toward the inside direction C1 by the torsion coil spring 15 provided in the frame unit 12 so that the leading edge T is pressed against the medium P at the edge E portion.

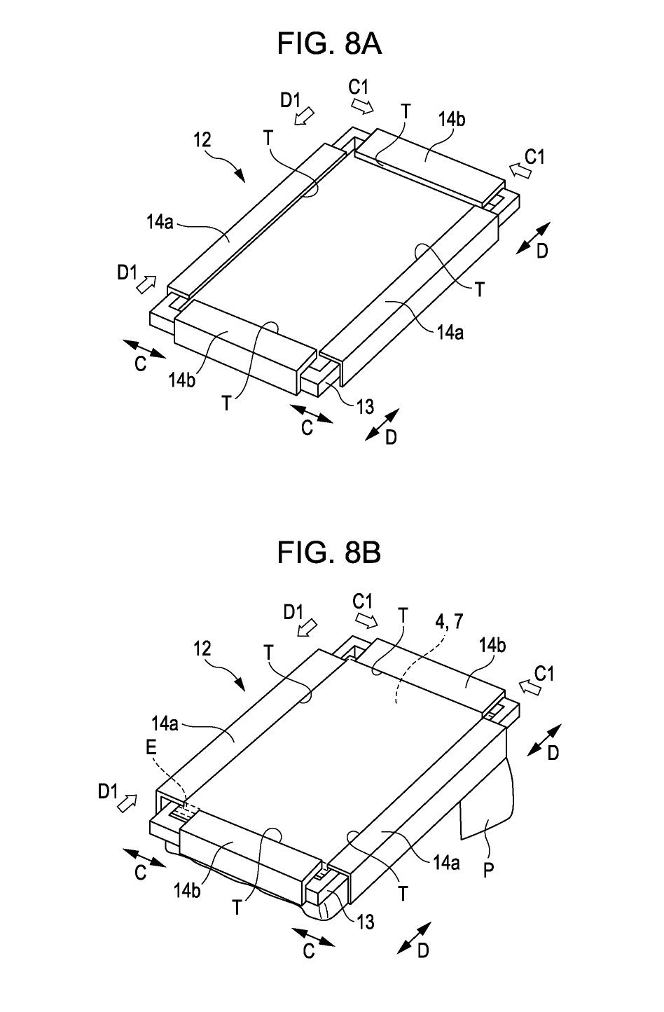

### Fourth Embodiment (FIGS. 8A and 8B)

Of FIGS. 8A and 8B, FIG. 8A is a schematic perspective view illustrating the frame unit 12 as a principal portion of a recording apparatus according to a fourth embodiment of the invention, and FIG. 8B is a perspective view illustrating a state in which the frame unit 12 is fitted onto the tray 4 on which the medium P is set.

As shown in FIG. 8A, moving members 14a and 14b are provided on the four sides of the rectangular base frame 13 in the frame unit 12 of this embodiment. Each of the moving members 14a is movable in the inside-outside direction C and is biased by the torsion coil spring 15 toward the inside direction C1. Further, each of the moving members 14b is movable in an inside-outside direction D of the base frame 13 and is biased by the torsion coil spring 15 toward an inside direction D1 of the base frame 13.

The frame unit 12 of this embodiment has the same configuration as the frame unit 12 of the first embodiment except that the moving members 14a and 14b are provided on the four sides of the base frame 13.

FIG. 8B is a perspective view illustrating a state in which the frame unit 12 is fitted onto the tray 4. In the frame unit 12 of this embodiment, the leading edges T of the moving members 14a and 14b provided in the frame unit 12 are pressed from the four sides of the base frame 13 against the medium P at the edge E portion of the tray 4 so that the medium P is held on the tray 4. As described above, pressing the leading edges T from the four sides of the base frame 13 makes it possible to more firmly hold the medium P on the tray 4 than the pressing in the frame unit 12 of the first embodiment. Moreover, it is possible to use the base frame 13 which is relatively larger compared to the tray 4 by configuring the frame unit 12 so that the medium P is held on the tray 4 through moving the moving members 14a and 14b like in the frame unit 12 of the first embodiment. This makes it possible to set media P of various thicknesses on the tray 4.

The entire disclosure of Japanese Patent Application No.2012-139343, filed Jun. 21, 2012 is expressly incorporated by reference herein.

What is claimed is:

1. A frame unit that holds a medium on a tray after the medium is set on the tray, comprising:
a base frame capable of being fitted onto an outer side of the tray on which the medium has been set; and
a moving member that is provided in the base frame and is movable in an inside-outside direction of the base frame.

2. The frame unit according to claim 1, further comprising:
a bias member that biases the moving member to an inside direction of the base frame.

3. The frame unit according to claim 1,
wherein the moving members are provided at least at positions opposite to each other of the base frame.

4. The frame unit according to claim 3,
wherein the tray and the base frame are quadrilateral and the moving members are provided on at least two opposing sides of the base frame.

5. The frame unit according to claim 2,
wherein a contact surface of the moving member with which the medium makes contact when the base frame is fitted is inclined with respect to a setting surface of the tray on which the medium is set so that the moving member is applied a force from the tray toward an outside direction of the base frame when the base frame is fitted onto the tray on which the medium has been set.

6. The frame unit according to claim 4,
wherein the moving members are provided on four sides of the base frame.

7. The frame unit according to claim 1, further comprising:
a knob that can be used when the moving member is moved.

8. A medium holding device comprising:
a tray on which a medium is set; and
the frame unit according to claim 1.

9. A medium holding device comprising:
a tray on which a medium is set; and
the frame unit according to claim 2.

10. A medium holding device comprising:
a tray on which a medium is set; and
the frame unit according to claim 3.

11. A medium holding device comprising:
a tray on which a medium is set; and
the frame unit according to claim 4.

12. A medium holding device comprising:
a tray on which a medium is set; and
the frame unit according to claim 5.

13. A medium holding device comprising:
a tray on which a medium is set; and
the frame unit according to claim 6.

14. A medium holding device comprising:
a tray on which a medium is set; and
the frame unit according to claim 7.

15. A recording apparatus comprising:
the medium holding device according to claim 8; and
a recording section that performs recoding on the medium.

16. A recording apparatus comprising:
the medium holding device according to claim 9; and
a recording section that performs recoding on the medium.

17. A recording apparatus comprising:
the medium holding device according to claim 10; and
a recording section that performs recoding on the medium.

18. A recording apparatus comprising:
the medium holding device according to claim 11; and
a recording section that performs recoding on the medium.

19. A recording apparatus comprising:
the medium holding device according to claim 12; and
a recording section that performs recoding on the medium.

20. A recording apparatus comprising:
the medium holding device according to claim 13; and
a recording section that performs recoding on the medium.
